(19) United States
(12) Patent Application Publication
(10) Pub. No.: US 2021/0242440 A1
(43) Pub. Date: Aug. 5, 2021

(54) LITHIUM ION BATTERY AND ENCLOSURE

(71) Applicant: Teledyne Energy Systems, Inc., Hunt Valley, MD (US)

(72) Inventors: Antonio Reis, Reisterstown, MD (US); Monroe Major, Glencoe, MD (US); Richard Sickenberger, Bel Air, MD (US)

(21) Appl. No.: 16/778,888

(22) Filed: Jan. 31, 2020

(51) Int. Cl. H01M 2/10; H01M 2/20; H01M 10/0525

(52) U.S. Cl. CPC H01M 2/1077; H01M 2/206; H01M 2/204; H01M 10/0525; H01M 2/105; H01M 2/1094

(57) ABSTRACT

Systems and methods of a battery assembly are disclosed. The battery assembly includes an extruded housing, a plurality of battery cells within the extruded housing forming a plurality of cell blocks, and a circuit coupled to the cell blocks and configured to connect one or more of the cell blocks selectively in parallel or series. A cell block within the plurality of cell blocks may be selectively isolated from each other cell block within the plurality of cell blocks using the circuit. The cell block within the plurality of cell blocks may include a series connected string of battery cells. The cell block within the plurality of cell blocks may include parallel connected battery cells.

### FIELD

The present disclosure relates generally to lithium ion batteries and, more particularly, to packaging systems or enclosures for lithium ion batteries.

### BACKGROUND

A lithium ion battery, in which a plurality of individual battery cells is housed within an enclosure, may be configured to provide a current source or a power source at a predetermined voltage threshold and used as a power source for various equipment or vehicles. Each of the plurality of individual battery cells typically includes a positive electrode, a negative electrode, an ionic electrolyte solution that facilitates the movement of ions back and forth between the two electrodes, and a porous separator membrane that allows for transport of ions between the electrodes and ensures the two electrodes do not physically contact one another. Performance of the lithium ion battery may be affected by temperature or humidity and, thus, improvements to the enclosure that account for these effects may provide various benefits to the battery. Further, systems or methods that enable construction of enclosures having differing characteristics tailored to specific operational considerations, e.g., a length of the battery or the resulting predetermined voltage threshold, may provide increased flexibility and reduced cost or reduced material waste in the fabrication of lithium ion batteries intended for various applications.

### SUMMARY

Systems and methods of a battery assembly are disclosed. A battery assembly may include an extruded housing, a plurality of battery cells within the extruded housing forming a plurality of cell blocks, and a circuit coupled to the cell blocks and configured to connect one or more of the cell blocks selectively in parallel or series.

A method of a battery assembly may include providing an extruded housing, providing a plurality of battery cells within the extruded housing forming a plurality of cell blocks, providing a circuit coupled to the cell blocks, and connecting one or more of the cell blocks selectively in parallel or series using the circuit.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 is a diagram illustrating an example battery module in accordance with the systems and methods described herein.

FIG. 2 is a diagram illustrating an example exploded view of the example battery cell housing of FIG. 1 in accordance with the systems and methods described herein.

FIG. 3 is a diagram illustrating a cross-sectional profile of the extruded case and the top cover of FIGS. 1 and 2 in accordance with the systems and methods described herein.

FIG. 4 is a diagram illustrating an example main enclosure 104 for the module of FIGS. 1 and 2 in accordance with the systems and methods described herein.

FIG. 5 is a diagram illustrating an example top cover for the module of FIGS. 1 and 2 in accordance with the systems and methods described herein.

FIG. 6 is a diagram illustrating an example of cell blocks for the module of FIG. 1 in accordance with the systems and methods described herein.

FIG. 7 is a diagram illustrating an example shape of a high temperature thermally conductive material for the module of FIGS. 1 and 2 in accordance with the systems and methods described herein.

FIG. 8 is a diagram illustrating an example of battery cell positioning within the module of FIGS. 1 and 2 in accordance with the systems and methods described herein.

FIG. 9 is a diagram illustrating an example of an individual block of cells, e.g., cell block, for the set of cell blocks of FIG. 6 in accordance with the systems and methods described herein.

FIG. 10 is a diagram illustrating an example of a cell bundle inserted into an extrusion, e.g., the extruded case.

FIG. 11 is a diagram illustrating an example first end cover for the module of FIGS. 1 and 2 in accordance with the systems and methods described herein.

FIG. 12 is a diagram illustrating an example second end cover for the module of FIGS. 1 and 2 in accordance with the systems and methods described herein.

FIG. 13 is a diagram illustrating an example of terminations using formed clips in the module of FIGS. 1 and 2 in accordance with the systems and methods described herein.

FIG. 14 is another diagram illustrating an example side view of terminations using formed clips in the module of FIGS. 1 and 2 in accordance with the systems and methods described herein.

FIG. 15 is a diagram illustrating an example of a terminal bus printed circuit board assembly (PCBA) arrangement in the module of FIGS. 1 and 2 in accordance with the systems and methods described herein.

FIG. 16 is a diagram illustrating an example battery pack assembly in accordance with the systems and methods described herein.

FIG. 17 is a diagram illustrating an example end of a battery module in accordance with the systems and methods described herein.

FIG. 18 is a diagram illustrating a set of modules such as the example module of FIG. 1 in accordance with the systems and methods described herein; and

FIG. 19 is a flowchart illustrating a method in accordance with the systems and methods described herein.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

An example embodiment may use thin-wall extruded shapes to form robust, rigid enclosures for lithium-ion cylindrical battery packs. Extruded shapes may allow for the inclusion of features that may be too expensive or may be too difficult to fabricate with other metal or plastic manufacturing methods. Extrusion fixtures may allow for low-cost manufacturing of battery packs that may be hermetically sealed and may provide for passive cooling methods that may be difficult with conventional cell enclosure methods. An example embodiment may allow for connections of cell blocks and control systems. In an example embodiment, the cell blocks and control systems may be assembled to provide robust restraint to the cells and control hardware within a reasonable weight and a reasonable volume. In another example embodiment, the use of extrusions may allow manufacturing of a family of battery packs without the need for inventory and storage of multiple enclosures. In another example embodiment, the use of extrusions may allow for high customization of battery packs without the need for application-specific enclosures. In another example embodiment, the use of extrusions in the manufacturing of battery packs allows for robust assemblies that are hermetically sealed without the use of fasteners. In another example embodiment, the use of extruded thin wall metallic shapes may allow for the use of phase-change material (PCM) liquids for the cooling of the battery packs at a low cost for manufacturing. The use of extruded thin wall metallic shapes may also allow for an enclosure having a low-weight.

An example embodiment may include the design, assembly, and integrated functionality of a suite of solutions to achieve optimization of a battery power system. An example embodiment may make use of thin-wall extruded shapes to create rigid, hermetic, and functional enclosures for lithium-ion battery packs. Using the systems and methods described herein, lithium-ion cells may be packaged with the enclosure walls to closely conform to the shape of the cells and may improve the robustness of the battery pack. The shapes used may allow for features that provide superior functionality and performance with low-cost manufacturing and low-weight. The systems and methods described herein may allow for features that allow minimizing the inventory and storage space of enclosures by allowing an extensive family of battery packs to be built from the same extruded stock. The matching enclosure extrusions may be assembled without the use of fasteners and specific sealing parts, further adding to the level of integration. In an example embodiment, the extruded strength adds significant resistance to damage and improves the safe handling of the battery pack.

Currently, there is a large variety of low-voltage (e.g., 14 V to 54 V) battery packs used across many sectors providing portable untethered power for many applications. Many of the portable battery power system applications may need to provide a high rate of discharge which may generate significant amounts of heat. Accordingly, a battery pack may benefit from an enclosure system that contributes to the heat dissipation during operation.

Today's many battery packs use plastic materials, most of the shrink type, to secure the cells together and protect the cells from the environment. Such a practice provides poor heat dissipation and poor protection of the cells. Today's battery packaging is low-cost and adds minimum weight to the battery pack.

An example embodiment, as described herein, may provide a better method to enclose the lithium-ion cells while providing a low-cost solution and remove complexity in the manufacturing process. An example embodiment may include thin-wall extruded profiles that assemble to make a hermetic enclosure. As one example, the extrusion may be designed so that it closely follows the contour of the cylindrical cells. The extrusion may have a length much longer (e.g., 5× to 20×) than the length of a single battery pack and one may manufacture the battery packs with various voltages and energy capacities by varying the pack's length. Each different battery pack length may use the same end covers. The top cover may also be made from a thin-wall extrusion and cut to length to serve the different battery packs. The extrusion profile may include features that allow higher functionality in the application such as a mounting location or mounting locations, a detent or detents, a cable support system or cable support systems. The various parts of the enclosure (e.g., the extrusions and the end covers) may be bonded together such that the finished enclosure may provide a hermetically-sealed package.

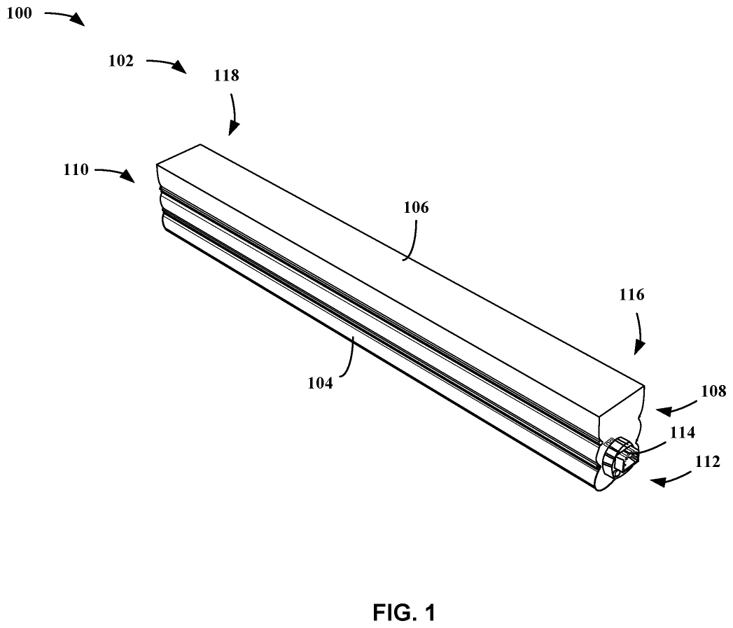

Referring now to the drawings, FIG. 1 is a diagram illustrating an example battery module 100 in accordance with the systems and methods described herein. The example battery module 100 may include a battery cell housing 102. The battery cell housing 102 includes an extruded case 104, a top cover 106, a first end cover 108, and a second end cover 110. In this example, the first end cover 108 includes aperture 112. Terminals 114 extend through the aperture 112 to provide access to one or more electrodes of the battery cell to facilitate an electrically conductive connection with the battery cell. In an example, the length of the module may change with voltage requirements or current requirements. For example, battery cells or blocks of battery cells may be arranged in series. Accordingly, in such an example, the length of the module may change with the voltage requirements. In another example, battery cells or blocks of battery cells may be arranged in parallel. Accordingly, in such an example, the length of the module may change with the current requirements. Furthermore, circuitry within the battery module 100 and/or connected to the battery module 100 may be switchable control series and parallel connections between the battery cells and or blocks of battery cells.

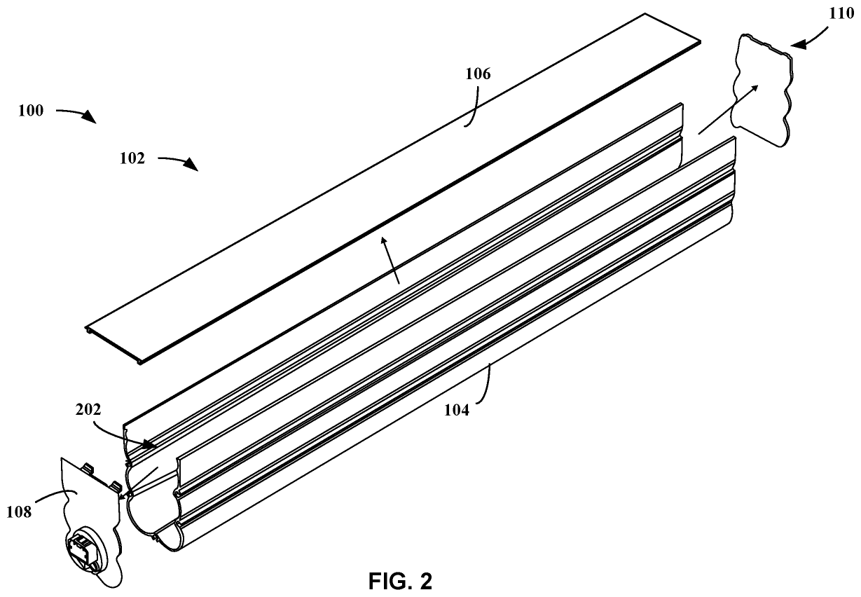

FIG. 2 is a diagram illustrating an example exploded view of the example battery cell housing 102 of FIG. 1 in accordance with the systems and methods described herein. As discussed above, the battery cell housing 102 includes an extruded case 104, a top cover 106, a first end cover 108, and a second end cover 110. The battery cell housing 102 may provide an open area 202 that may receive cell blocks. The extruded case 104 may be considered an extruded tube, extruded sleeve, or an extruded can. To enclose the cell blocks within the open area, the first end cover 108 may be secured to a first end portion (e.g., first end) of the extruded case 104, and the second end cover 110 may be secured to an opposing, second end portion (e.g., second end) of the extruded case 104.

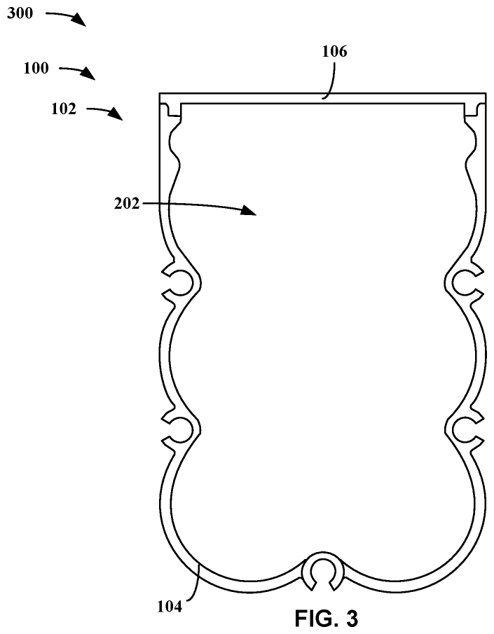

FIG. 3 is a diagram illustrating a cross-sectional profile 300 of the extruded case 104 and the top cover 106 of FIGS. 1 and 2 in accordance with the systems and methods described herein. As discussed above. the battery cell housing 102 may provide an open area 202 that may receive cell blocks. For example, the extruded case 104 and the top cover 106 (along with the first end cover 108, and the second end cover 110 of FIGS. 1 and 2) may form an enclosed area that includes an open area 202 that may receive cell blocks. The top cover 106 may be shaped to slide into the extruded case 104, snap into the extruded case 104, or otherwise connect to the top cover 106. The top cover 106 may be glued, bonded, welded, fused, soldered, brazed, or cemented to the extruded case 104, or otherwise secured or joined to the top cover 106.

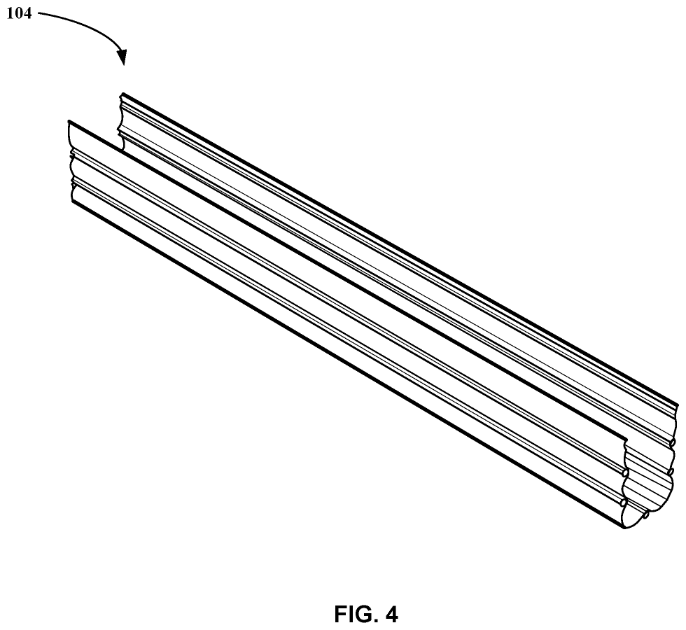

FIG. 4 is a diagram illustrating an example main enclosure formed from the extruded case 104 for the module of FIGS. 1 and 2 in accordance with the systems and methods described herein. The example extruded case 104 may be extruded and cut to length to provide for the various module lengths. For example, as discussed above, the extruded case 104 may be formed using an extrusion process. During an example extrusion process, a material may be pushed through a die to form a cross-sectional profile of the extruded case 104. The material of the extruded case 104 may be aluminum, or any other material suitable for an extrusion process.

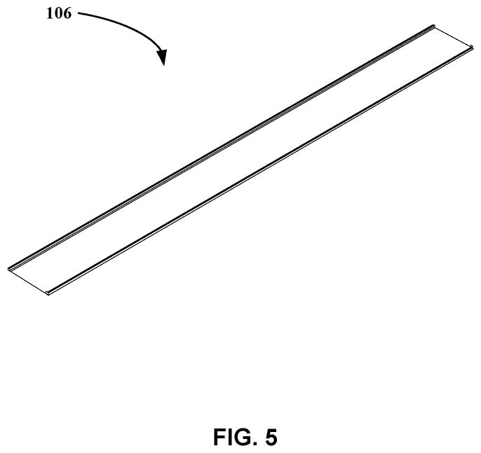

FIG. 5 is a diagram illustrating an example top cover 106 for the module of FIGS. 1 and 2 in accordance with the systems and methods described herein. The example top cover 106 may be extruded and cut to length to provide for the various module lengths. As discussed above, during an example extrusion process, a material may be pushed through a die to form a cross-sectional profile of the extruded case 104. The material of the top cover 106 (which may be an extruded top cover) may be aluminum, or any other material suitable for an extrusion process. The top cover 106 may be cut from extruded material and cut from the extruded material at one or more ends to the dimension “L” of the extruded case 104, e.g., so that the top cover 106 and the extruded case 104 may be the same length or approximately the same length, e.g., depending on how the top cover 106 attaches to the end covers, e.g., first end cover 108 and second end cover 110.

As discussed above, both parts may be extruded and cut to length to provide for the various module lengths. The enclosures may provide system enclosures that provide structural confinement for components and a way to safely handle both installed batteries or batteries outside the application.

In an example embodiment, the extrusions may provide features for the bonding of the two parts, e.g., tabs, ridges, channels, or other features that may provide for bonding the components together. In an example embodiment, the main enclosure may conform with the cells and provide for dissipation of heat from the cells, as described herein.

The top cover 106 forms part of an enclosure that may provide structural confinement for the components of the battery module 100 and means for safe handling both a battery module 100 that has been installed and a battery module 100 outside a battery application. The extrusions may provide features for the bonding of the top cover 106 to the extruded case 104.

Referring to FIGS. 1-5, the extruded case 104 may be formed using an extrusion process. During an example extrusion process, a material may be pushed through a die to form a cross-sectional profile of the extruded case 104. The material of the extruded case 104 may be aluminum, or any other material suitable for an extrusion process.

The extruded case 104 may be cut from the material that has been pushed through the die. For example, the extruded case 104 may be cut from the material at a side 116, cut from the material at an opposing side 118, or cut from both sides, e.g., side 116 and the opposing side 118. As may be appreciated, the dimension “L” of the extruded case 104 may be based on where the side 116 is cut relative to the opposing side 118. The locations of the cuts can be changed if an extruded case with an increased or decreased dimension “L” is desired. The same die and other extrusion tooling may be used to create a plurality of extruded cases each having different dimensions “L.” Accordingly, the length of the battery module 100 may be changed for different voltage requirements, different voltage requirements, or a combination of different voltage requirements and different current requirements. For example, a longer battery module (e.g., battery module 100) may include more battery cells, e.g., of a given size, as compared to a shorter battery module (e.g., battery module 100). Depending on how the battery cells are connected, voltage, current, or voltage and current may be increased or decreased by increasing or decreasing the number of battery cells. For example, if each battery cell in a line of battery cells are connected in series, the voltage may be increased by increasing the length “L,” e.g., in increments based on battery cell length. In such an example, current available may be increased by increasing the number of lines of battery cells.

The battery cells may be placed in the open area such that an axis of the battery cells is aligned with the direction of extrusion. In another example, the battery cells may be placed in the open area such that the axis of the battery cells are transverse to the direction of extrusion.

In an example embodiment, the first end cover 108 and the second end cover 110 may be secured to the extruded case 104 by crimping, screwing, bolting, riveting, braising, welding, or another attachment technique. The first end cover 108 and the second end cover 110 may be aluminum in an example embodiment but could be made from other materials. The first end cover 108 and the second end cover 110 may be the same material as the extruded case 104, or a different material than the extruded case 104. For example, the first end cover 108 and the second end cover 110 may be cast or machined into a desired dimension.

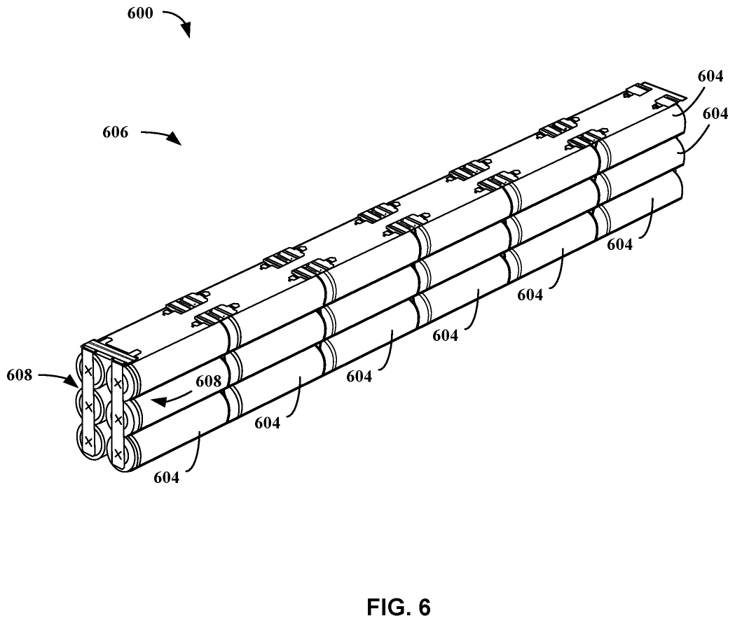

FIG. 6 is a diagram illustrating an example of cell blocks 602 for the module of FIGS. 1 and 2 in accordance with the systems and methods described herein. A plurality of battery cells 604 that may be placed within the extruded case of FIGS. 1 and 2 may form the plurality of cell blocks 602. An array 606 of the battery cells 604 includes individual battery cells, e.g., a first battery cell, a second battery cell, or other individual battery cells of a plurality of battery cells 604, which may be connected in cell blocks 602, e.g., an adjacent groups of battery cells. For example, a battery cell, e.g., a second battery cell, of an adjacent group of battery cells may be connected in parallel and may be laser welded to a second cell tab. Each of the cell blocks 602 may be disposed along an axis and sandwiched axially between endplates. The array 606 of battery cells 604 may include thirty-six of the battery cells 604 in the illustrated example. However, it will be understood that the number of battery cells 604 selected and used may vary depending on the voltage and/or current needs of a device being powered by the battery. The battery cells 604 may include terminals that electrically couple each of the battery cells 604 individually to a bus bar 608, or some other structure, to transfer electrical power to and from the battery cells 604.

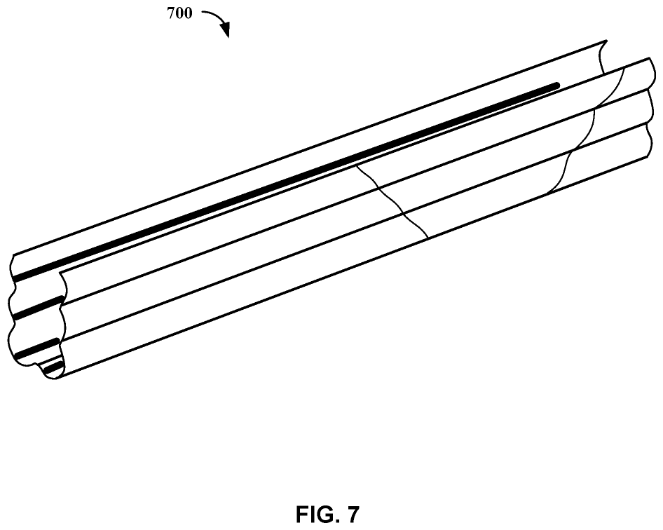

FIG. 7 is a diagram illustrating an example shape of a high temperature thermally conductive material 700 for the module of FIGS. 1 and 2 in accordance with the systems and methods described herein. The shape of the enclosure of FIGS. 1 and 2 may allow for precise positioning of cells in relation to the enclosure. A thin sheet containing a high temperature thermally conductive material 700 may be used to keep the cells within the assembly while allowing a greater degree of heat dissipation. The high temperature thermally conductive material 700 may be a thermally conductive polyurethane based product such as a thermally conductive hard polyurethane. One example of a thermally conductive hard polyurethane is WEVOPUR. Accordingly, in one example, a fabric impregnated with WEVOPUR may be used as the high temperature thermally conductive material 700 of FIG. 7. Information on WEVOPUR may be found at https://www.wevo-chemie. de/en/your-industry/energy/products/wevopur/.

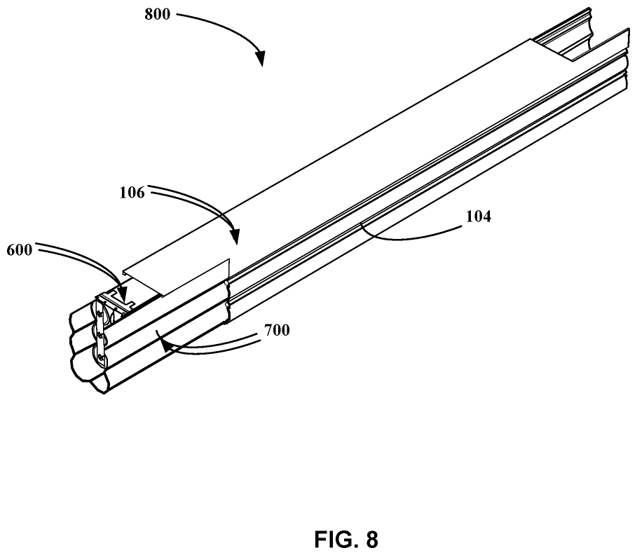

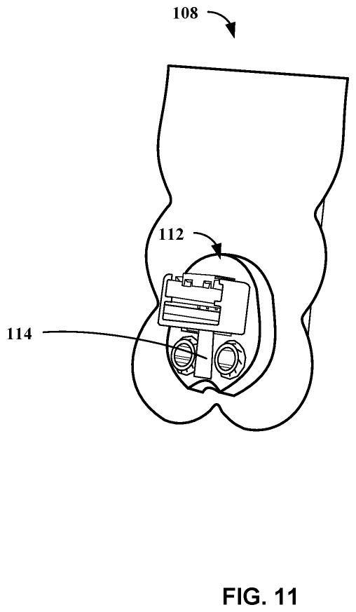

FIG. 8 is a diagram illustrating an example of battery cell positioning 800 within the module of FIGS. 1 and 2 in accordance with the systems and methods described herein. FIG. 8 provides a cutaway view illustrating an example of battery cell positioning 800 within the module of FIGS. 1 and 2 including an extruded case 104 (cutaway), a top cover 106, the plurality of cell blocks 600, and the high temperature thermally conductive material 700. As illustrated in the example of FIG. 8, in one example embodiment, the plurality of cell blocks 600 may be covered by the high temperature thermally conductive material 700. The plurality of cell blocks 600 and the high temperature thermally conductive material 700 may be covered or enclosed by the extruded case 104 (cutaway) and the top cover 106, as well as the first end cover 108 and the second end cover 110 illustrated in FIGS. 1 and 2 (as well as FIGS. 11, 12 and 16, discussed below).

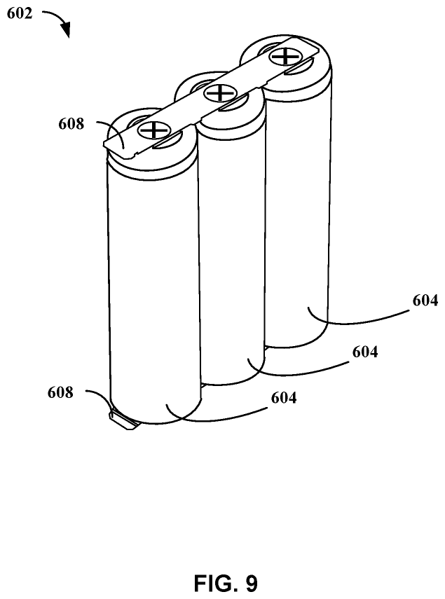

FIG. 9 is a diagram illustrating an example of an individual block of cells, e.g., an individual cell block of the cell blocks 602, for the set of cell blocks of FIG. 6 in accordance with the systems and methods described herein. As illustrated in FIG. 6, the cell blocks 602 may be combined in various numbers depending on current needs, voltage needs, or both for a system or device being powered. For example, the number of battery cells 604 in a cell block in the illustrated example is three but may vary from one to as many battery cells 604 needed to supply a desired voltage. Furthermore, the number of cell blocks 602 may vary from one to a number needed to supply a desired current for a desired time. Furthermore, as described herein, larger numbers of battery cells 604 and/or cell blocks 602 may be used and battery cells 604 and/or cell blocks 602 may be switched in and out of use and in and out of being charged as needed. The cell blocks 602 may be parallel-connected and may be assembled in a separate manufacturing process where the number of battery cells 604 (e.g., three) may be attached to cell tabs using laser welding or other means of achieving a robust electrical path. For example, the number of battery cells 604 (e.g., three) may be attached to a first cell tab and/or a second cell tab.

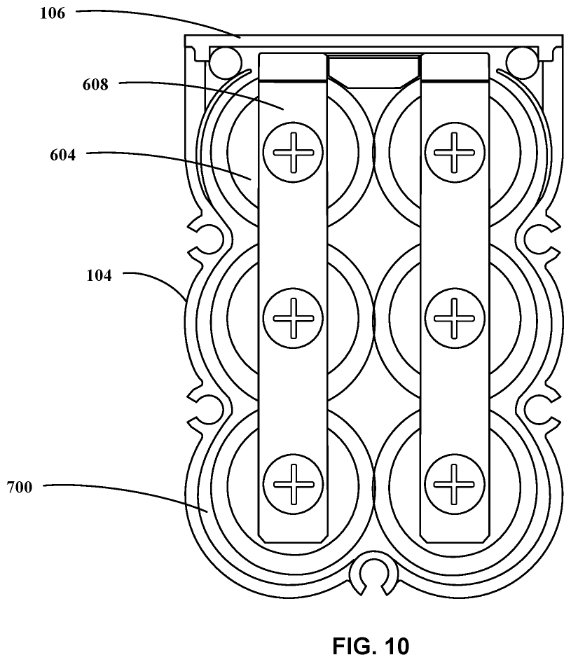

FIG. 10 is a diagram illustrating an example of a cell bundle inserted into an extrusion, e.g., the extruded case 104. The cell bundle may include the battery cells 604. The battery cells 604 may be in cell blocks 602. The cell blocks 602 may be within a high temperature thermally conductive material 700. For example, two sets of parallel sets of cell blocks 602 may be within the high temperature thermally conductive material 700. The cell blocks may further be covered by the battery cell housing 102.

Assembling the battery system may include precutting the thin-wall extrusion to the thin-wall extrusion's final dimensions. Assembling the battery system may also include surface treating the thin-wall extrusion to the thin-wall extrusion's cosmetic look. In a separate process, the lithium-ion cells may be terminated to meet the required voltage level, current capacity, or both. The lithium-ion cells may be arranged in a bundle that may be inserted into the extrusion, as illustrated in FIG. 10. Different modules may be assembled depending on the number of cell blocks (e.g., length of the battery pack) or the connection of the cells (e.g., series or parallel-connected).

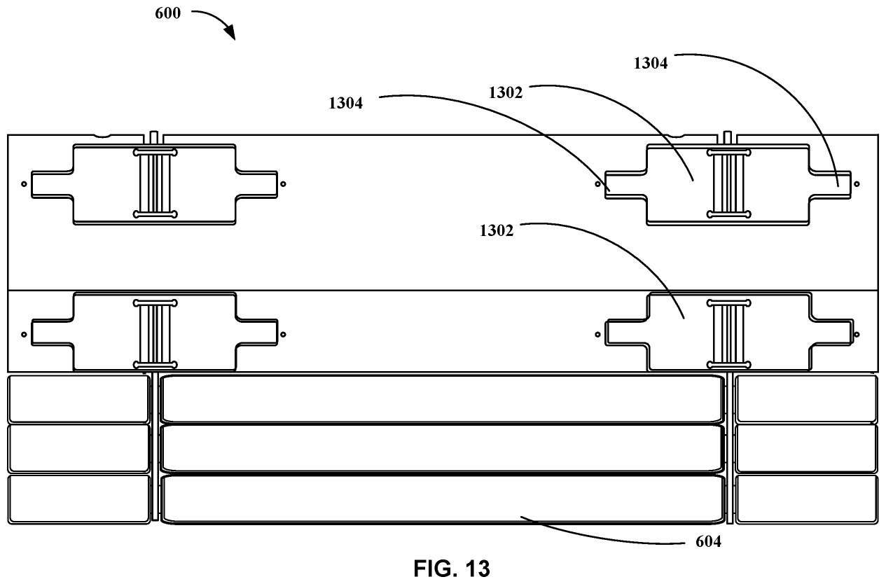

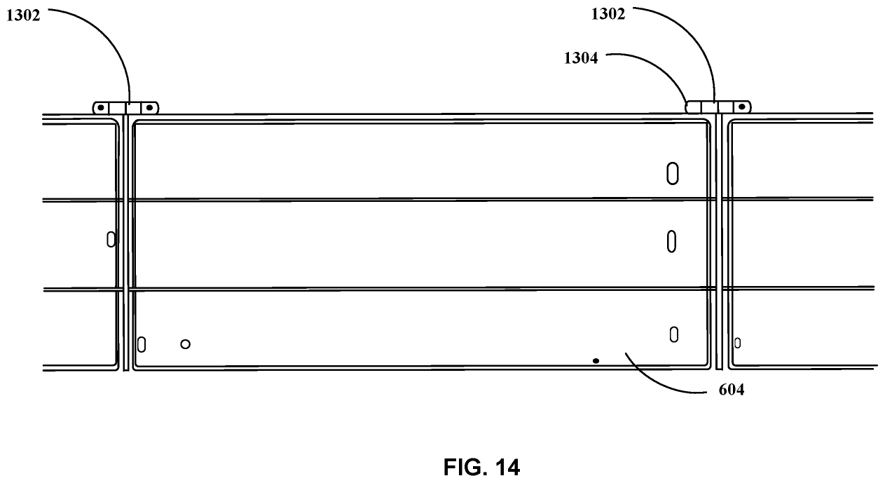

A parallel-connected cell block may be assembled in a separate manufacturing process where the number of cells (e.g., three) may be attached to cell tabs using laser welding or other means of achieving a robust electrical path. The parallel-connected cell block assembly may be terminated with the adjacent cell by placing the cell tabs in electrical contact either by welding or the help of fasteners (as illustrated in FIGS. 13 and 14) or hardware.

FIG. 11 is a diagram illustrating an example first end cover 108 for the module of FIGS. 1 and 2 in accordance with the systems and methods described herein. The first end cover 108 may provide feedthrough communication and feedthrough power to the application. The first end cover 108 may provide for tight sealing of the module internal to the environment. The example first end cover 108 may be welded, laser welded, or otherwise connected to the extruded components to form a sealed battery enclosure, as described herein.

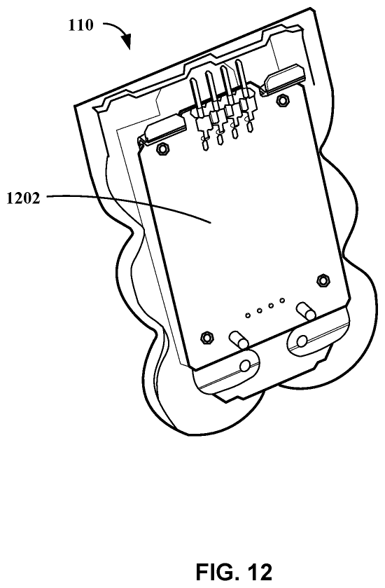

FIG. 12 is a diagram illustrating an example second end cover 110 for the module of FIG. 1 in accordance with the systems and methods described herein. A printed circuit board assembly (PCBA) 1202 may include integrated circuits (ICs). The ICs in the second end cover 110 may provide for electrical isolation of the individual modules. For example, the ICs may provide transistors or other switches to provide for electrical isolation of the individual modules. Transistors and/or other switches may be provided within the example battery module 100 or may be used to provide for electrical isolation of an individual battery module, e.g., isolation of a battery module 100 or multiple battery modules. The example second end cover 110 may be welded, laser welded, or otherwise connected to the extruded components to form a sealed battery enclosure, as described herein.

In an example embodiment, a thin-wall extrusion may be precut to its final dimensions. The thin-wall extrusion may also be surface treated for a desired cosmetic look. The thin-wall extrusion may be assembled with the first end cover 108 and the second end cover 110 as well as the top cover 106 to form a battery system including the battery module 100.

FIG. 13 is a diagram illustrating an example of terminations using formed clips 1302 in the module of FIGS. 1 and 2 in accordance with the systems and methods described herein. FIG. 14 is a diagram illustrating an example side view of terminations using the formed clips 1302 in the module of FIGS. 1 and 2 in accordance with the systems and methods described herein. An example embodiment may use a formed clip of the formed clips 1302, e.g., a formed copper clip, as illustrated in FIGS. 13 and 14. In an example, terminations may be formed using at least one formed clip, e.g., one of the formed clips 1302. The formed clip of the formed clips 1302 may provide a means for electrical contact while creating a cavity around two tab-ends 1304. In an example embodiment, the cavity around the two tab-ends 1304 may be filled with solder and provide a good heat-sink to absorb the heat from the tabs. Because the formed clips 1302 may provide a large surface area, substantial heat dissipation may be achieved to the enclosure, e.g., the battery cell housing 102, by using an electrically isolating, and high temperature thermally conductive material, such as those from Wevo-Chemie, across the surface of the clip.

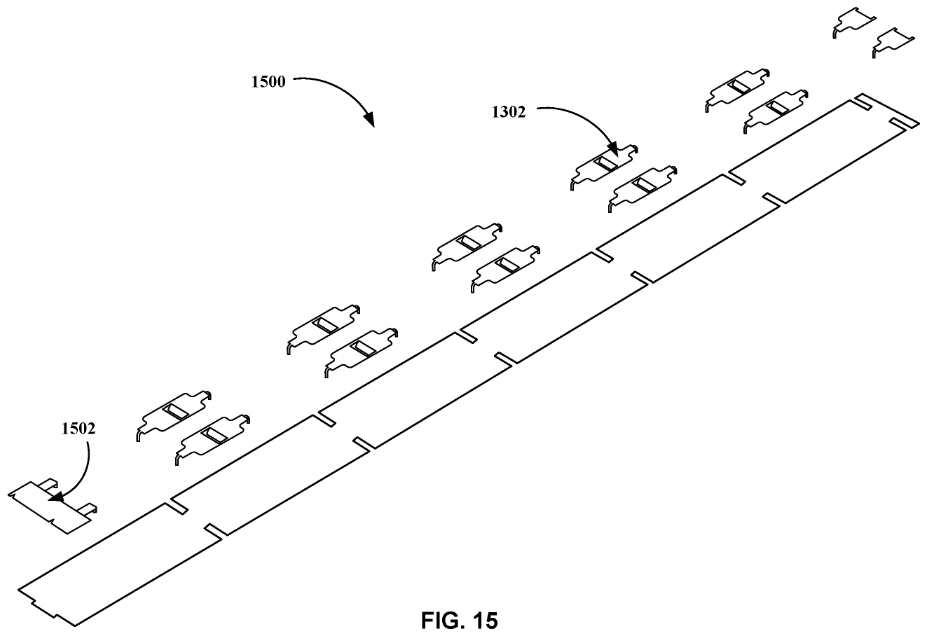

FIG. 15 is a diagram illustrating an example of a terminal bus printed circuit board assembly (PCBA) (Bus PCBA 1500) arrangement that may be used in the example module of FIGS. 1 and 2 in accordance with the systems and methods described herein. The extremities of the formed clips 1302, and formed clip 1502 are connected to the Bus PCBA 1500 and one can perform the battery management system (BMS) functions requirements at a much lower temperature. BMS functions may include controlling charging and discharging operations of the battery cells 604, e.g., based on status information of the battery cells 604 which may include, but is not limited to, state of charge, state of discharge, temperature, charge-discharge cycles, and any other information that may impact the performance of a battery cell of the battery cells 604.

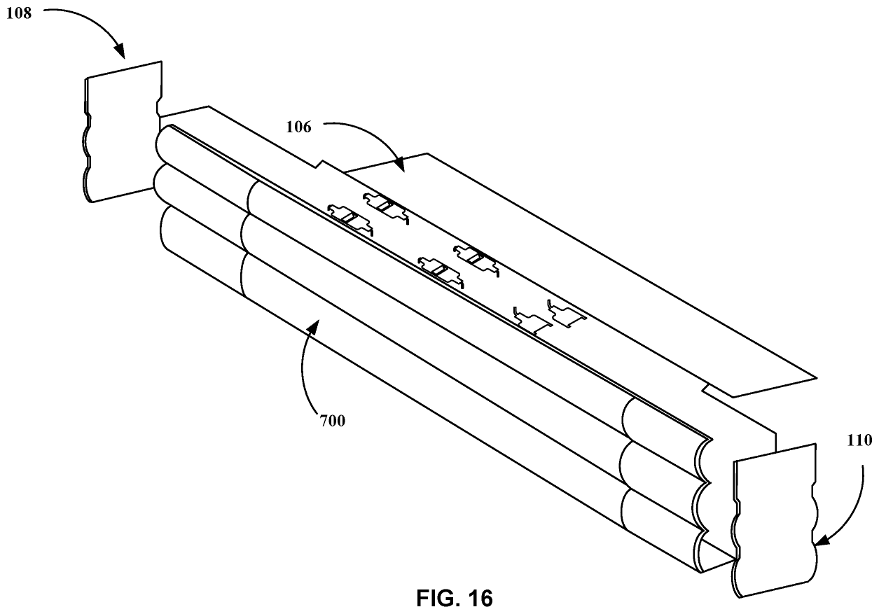

FIG. 16 is a diagram illustrating an example battery pack assembly 1600 in accordance with the systems and methods described herein. The example battery pack assembly 1600 includes the top cover 106, the first end cover 108, and the second end cover 110. The battery cell housing 102 of FIGS. 1 and 2 is omitted to allow for illustration of the high temperature thermally conductive material 700 of FIG. 7 installed on a set of battery cells 604. A thin sheet containing a high temperature thermally conductive material 700 may be used to keep the cells within the assembly while allowing a greater degree of heat dissipation. The high temperature thermally conductive material 700 may be a thermally conductive polyurethane based product such as a thermally conductive hard polyurethane. Additionally, the use of thermally conductive materials may provide added stability to the cells improving resistance to damage under extreme vibration.

The ability to integrate the control PCBA in the electrical bus of the battery pack allows for elimination of wires and reduction of complexity in the assembly of the battery pack.

In another example embodiment, the high temperature thermally conductive material 700 may be a flame-resistant material to isolate the cells from each other and from the enclosure. The flame-resistant material may, at least temporarily, slow the spread of flames in the case of a fire. Because the material is less combustible, the material may retain the cells in place longer.

The flame-resistant material may be a poor conductor of heat. In applications that require heat dissipation, the material may be soaked with a liquid that enables the heat transfer. The liquid may be chosen such that the surface tension of the material is much greater than the surface tension of the liquid and therefore the material acts as a wick, substantially lowering the liquid volume for effective heat transfer.

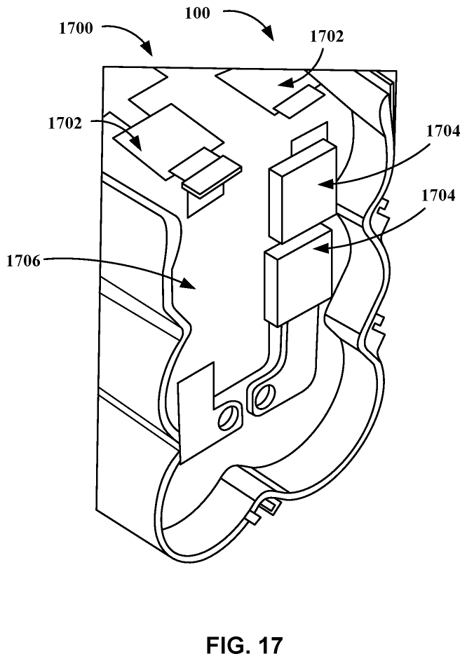

FIG. 17 is a diagram illustrating an example end 1700 of a battery module 100 in accordance with the systems and methods described herein. The end 1700 of a battery module 100 includes terminal connections 1702, isolation metal-oxide-semiconductor field-effect transistors (MOSFETS) 1704, and a supervisory PCBA 1706. The illustrated example of FIG. 17 includes MOSFETS 1704. In other examples, other types of transistors, such as bipolar junction transistors or other switches, may be used.

In an example embodiment, the supervisory PCBA 1706 may house circuits to monitor voltage and temperature as well as cell balance circuits. The components of supervisory PCBA 1706 may be mounted near the voltage and temperature sources. Because the components of supervisory PCBA 1706 mounted may be near the voltage and temperature sources, the arrangement may provide a robust and accurate method for monitoring and controlling the battery pack. Using isolated communication systems, the battery pack controls may be isolated from the rest of the system and such a pack may provide an intrinsically safe power source.

In an example embodiment, to further simplify the assembly process, increase the level of integration, and reduce volume and weight, a supervisory PCBA 1706 may be integrated in the battery pack assembly. In an example embodiment, the supervisory PCBA 1706 connects to the battery cell bundle and Bus PCBA in the same manner as the cell blocks, eliminating the need for wires.

In an example embodiment, the supervisory PCBA 1706 provides electrical connection for the battery pack feedthrough that, in turn, allows powering the application yet providing a hermetically-closed system. In an example embodiment, the supervisory PCBA 1706 houses the isolation MOSFETs that enable the isolation of the system from the application and prevent the system from operating in adverse conditions considered either undesirable by the application or unsafe.

In an example embodiment, the Bus PCBA 1500 Functions may include synchronizing with a trigger from the supervisory PCBA 1706. In an example embodiment, the Bus PCBA 1500 Functions may include measuring cell voltages. In an example embodiment, the Bus PCBA 1500 Functions may include measuring cell temperatures. For example, the Bus PCBA 1500 may include an electronic temperature measurement device proximal to the cells to be measured.

In an example embodiment, the Bus PCBA 1500 Functions may include identifying violations. For example, the Bus PCBA 1500 may include a list of violations that may be tested for using various measurements or data readings. The Bus PCBA 1500 may take measurements and compare measured values against the list of violations to determine when a violation has occurred.

In an example embodiment, the Bus PCBA 1500 Functions may include sending data to the supervisory PCBA 1706. For example, the Bus PCBA 1500 may include a data connection to the supervisory PCBA 1706. Accordingly, data may be sent to the supervisory PCBA 1706.

In an example embodiment, the Bus PCBA 1500 Functions may include receiving data from supervisory PCBA 1706. For example, the Bus PCBA 1500 may include a data connection to the supervisory PCBA 1706. Accordingly, data may be received from the supervisory PCBA 1706.

In an example embodiment, the Bus PCBA 1500 Functions may include balancing the cells within the blocks. For example, the Bus PCBA 1500 may measure voltages at individual cells or small groups of cells and charge or discharge the individual cells or small groups of cells to balancing the cells within the blocks.

In an example embodiment, the Bus PCBA 1500 Functions may include calculating power shuffle within cell blocks. Power shuffling may include transferring energy from one cell to another adjacent cell. For example, with four series-connected cells, a first cell having the highest potential and a fourth cell having the lowest potential, one can move energy from the first cell to the fourth cell using multiple power shuffles by moving energy from the first cell to the second cell, from the second cell to the third cell, and finally from the third cell to the fourth cell.

In an example embodiment, the Bus PCBA 1500 Functions may include balancing up and down to adjacent blocks. For example, the Bus PCBA 1500 may measure voltages at individual cells or small groups of cells and charge or discharge the individual cells or small groups of cells as compared to adjacent blocks to balancing up and down to adjacent blocks.

In an example embodiment, the supervisory PCBA 1706 Functions may include synchronizing with a trigger from a master control. In an example embodiment, the Bus PCBA 1500 Functions may include aggregating cell voltage measurements. For example, cell voltage measurements from the Bus PCBA 1500. These measurements may be aggregated together. In an example embodiment, the supervisory PCBA 1706 Functions may include aggregating cell temperature measurements to identify violations. For example, based on violation definitions stored at the supervisory PCBA 1706, such as over-voltages or under-voltages.

In an example embodiment, the supervisory PCBA 1706 Functions may include managing battery switch gear. The switching gear may switch individual battery cells or small groups of battery cells.

In an example embodiment, the supervisory PCBA 1706 Functions may include managing current sensors. For example, the supervisory PCBA 1706 may be coupled to one or more current sensors and may control when the current sensors take current measurements. In some examples, one or more current measurement devices may be switched between multiple cells or groups of cells to measure current for the one or more cells or groups of cells individually.

In an example embodiment, the supervisory PCBA 1706 Functions may include calculating battery state-of-charge (SOC). For example, SOC for the battery may be calculated based on one or more of system voltage and current within the battery. One example may base SOC on each cell in the battery.

In an example embodiment, the supervisory PCBA 1706 Functions may include sending data to master control. For example, the supervisory PCBA 1706 may have a data connection with the master control. Accordingly, the supervisory PCBA 1706 may send data to the master control.

In an example embodiment, the supervisory PCBA 1706 Functions may include receiving data from master control. For example, the supervisory PCBA 1706 may have a data connection with the master control. Accordingly, the supervisory PCBA 1706 may receive data to the master control.

In an example embodiment, the supervisory PCBA 1706 Functions may include sending data to Bus PCBA 1500. For example, the supervisory PCBA 1706 may have a data connection with the Bus PCBA 1500. Accordingly, the supervisory PCBA 1706 may send data to Bus PCBA 1500.

In an example embodiment, the supervisory PCBA 1706 Functions may include receiving data from bus PCBA 1500. For example, the supervisory PCBA 1706 may have a data connection with the bus PCBA 1500. Accordingly, the supervisory PCBA 1706 may receive data to the bus PCBA 1500.

In an example embodiment, the supervisory PCBA 1706 Functions may include calculating balancing between cell blocks. For example, the supervisory PCBA 1706 may measure voltages at individual cells or small groups of cells and charge or discharge the individual cells or small groups of cells to balancing the cells within the blocks.

In an example embodiment, the supervisory PCBA 1706 Functions may include calculating power shuffle between cell blocks. The supervisory PCBA may determine when and the duty-cycle of the energy balancing of the cell blocks.

In an example embodiment, the Master Control Board functions may include one or more of generating and broadcasting signal triggers so that all collected date may be relative to a specific time. In an example embodiment, the Master Control Board Functions may include synchronizing a trigger with the supervisory PCBA 1706. The Master Control Board may be located on one or more of the various circuit boards illustrated in the figures.

In an example embodiment, the Master Control Board Functions may include identifying violations. For example, a list of violations may be maintained and tested for. When violations occur, they may be signaled to a user of the battery or other systems within the battery or the device using the battery.

In an example embodiment, the Master Control Board Functions may include managing an awake system.

In an example embodiment, the Master Control Board Functions may include managing main switch gear. For example, the Master Control Board may control isolation of cells within the battery. Accordingly, individual cells or small groups of cells may be used depending on voltage and current needs of a system being powered by the battery.

In an example embodiment, the Master Control Board Functions may include managing a system current sensor. The Master Control Board may determine when current measurements are taken using such devices. In some examples, one or more current measurement devices may be switched between multiple cells or groups of cells to measure current for the one or more cells or groups of cells individually.

In an example embodiment, the Master Control Board Functions may include calculating overall SOC.

In an example embodiment, the Master Control Board Functions may include storing maximum and minimum cell voltages. For example, voltage measurements for cells may be taken and stored in a memory. In some examples, only maximum and minimum cell voltages are stored. Accordingly, in an aspect, two memory locations with enough bits to store a voltage measurement may be needed for each cell (or small group of cells) being measured.

In an example embodiment, the Master Control Board Functions may include storing maximum and minimum cell temperatures. For example, cell temperature measurements may be taken and stored in a memory. In some examples, only maximum and minimum cell temperatures are stored. Accordingly, in an aspect, two memory locations with enough bits to store a cell temperature may be needed for each cell (or small group of cells) being measured.

In an example embodiment, the Master Control Board Functions may include calculating overall maximum and minimum current limits. For example, current limits may be based on a number of cells in parallel. The Master Control Board may track the number of cells in parallel and may be able to calculate the maximum and minimum current.

In an example embodiment, the Master Control Board Functions may include sending data to supervisory PCBA 1706. For example, the Master Control Board Functions may include a data path to supervisory PCBA 1706. Accordingly, the Master Control Board Functions may send data to supervisory PCBA 1706.

In an example embodiment, the Master Control Board Functions may include receiving data from supervisory PCBA 1706. For example, the Master Control Board Functions may include a data path to supervisory PCBA 1706. Accordingly, the Master Control Board Functions may receive data to supervisory PCBA 1706.

In an example embodiment, the Master Control Board Functions may include sending data to a Vehicle Master Unit (VMU). For example, the Master Control Board Functions may include a data path to the VMU. Accordingly, the Master Control Board Functions may send data to the VMU.

In an example embodiment, the Master Control Board Functions may include receiving data from VMU. For example, the Master Control Board Functions may include a data path to the VMU. Accordingly, the Master Control Board Functions may receive data from the VMU.

An example embodiment may include an ability to discharge all cells to a specific voltage at 100% depth of discharge (DoD or 0% SOC). Because of the capabilities to isolate every cell block in a series-connected string, the systems and methods described herein may be able to discharge the cells to each cell's low-voltage limit allowing for initiating charging with all cells balanced. An example embodiment may include an ability to isolate parallel-connected battery packs and therefore, with the aid of the master control, the systems and methods described herein may charge the packs without the need for separating the packs.

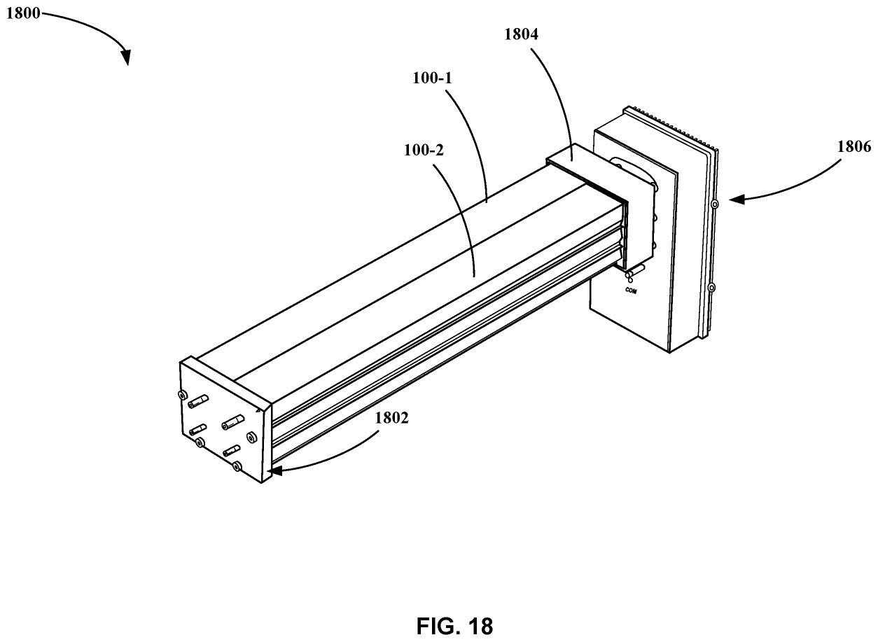

FIG. 18 is a diagram illustrating a set of modules 1800 such as the example battery module 100 of FIGS. 1 and 2 in accordance with the systems and methods described herein. The battery module 100 may be aggregated in series or parallel-connected systems. For example, in an example embodiment, a first battery module (e.g., battery module 100-1) may be connected in parallel with a second battery module (e.g., battery module 100-2). Accordingly, the voltage of the combined set of modules 1800 may be equal to the voltage of each battery module 100. Parallel-connected systems may provide a larger desired current.

In another example embodiment, a first battery module (e.g., battery module 100-1) may be connected in series with a second battery module (e.g., battery module 100-2). Accordingly, the voltage of the combined set of modules 1800 may be an addition of the voltage of battery module 100-1 and the battery module 100-2. Series-connected systems may provide a desired voltage level. In some examples, 750 volts direct current (VDC) may be possible, depending on the number of battery cells or modules connected in series. One example may be an integrated system providing, e.g., 42 VDC at 20 Ah with the two battery modules connected in parallel, e.g., battery module 100-1 connected in parallel to another battery module 100-2. Series connections, parallel connections, or a combination of series connections and parallel connections may be made at the end connectors 1802, 1804 or at connection point 1806.

Additionally, the two battery modules (e.g., battery module 100-1 and battery module 100-2) may be independently isolated and charged from a single point, e.g., through the connection point 1806, one or more of the end connectors 1804, or each of the connection point 1806 and the end connectors 1804. For example, transistors or other switches may be provided within one or more of connection point 1806 or the end connectors 1804 to provide for electrical isolation of the individual battery modules (e.g., battery module 100-1 and battery module 100-2). In an example embodiment, the enclosure may be constructed from bonded extrusions allowing for inexpensive assembly and robust protection of the cells and electronics.

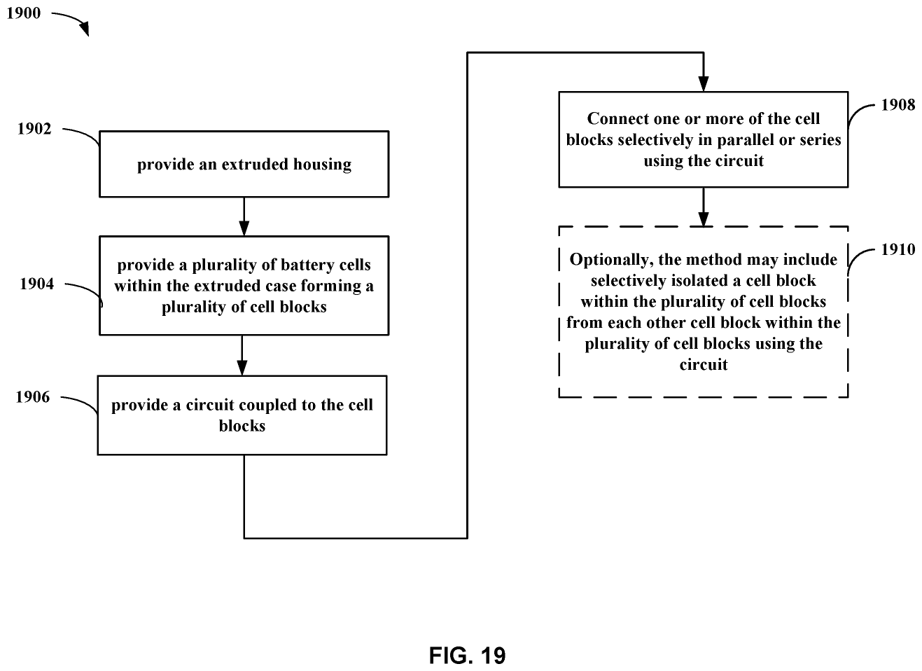

FIG. 19 is a flowchart illustrating a method 1900 in accordance with the systems and methods described herein. The method 1900 includes providing an extruded housing (1902), providing a plurality of battery cells within the extruded case forming a plurality of cell blocks (1904), providing a circuit coupled to the cell blocks (1906), and connecting one or more of the cell blocks selectively in parallel or series using the circuit (1908). Optionally, the method may include selectively isolated a cell block within the plurality of cell blocks from each other cell block within the plurality of cell blocks using the circuit (1910).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public, regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. A battery assembly, comprising:
an extruded housing;
a plurality of battery cells within the extruded housing forming a plurality of cell blocks; and
a circuit coupled to the plurality of cell blocks and configured to connect one or more of the plurality of cell blocks selectively in parallel or series.

2. The battery assembly of claim 1, wherein a cell block within the plurality of cell blocks is selectively isolated from each other cell block within the plurality of cell blocks using the circuit.

3. The battery assembly of claim 2, wherein the cell block within the plurality of cell blocks comprises battery cells connected in series.

4. The battery assembly of claim 3, wherein the battery assembly is configured to discharge all cells to a specific voltage by selectively isolated individual cell blocks within the plurality of cell blocks from other cell blocks within the plurality of cell blocks using the circuit.

5. The battery assembly of claim 2, wherein the cell block within the plurality of cell blocks comprises battery cells connected in parallel.

6. The battery assembly of claim 5, wherein the battery assembly is configured to charge the cell block of the plurality of cell blocks.

7. The battery assembly of claim 5, wherein a first battery cell of the battery cells connected in parallel is laser welded to a first cell tab.

8. The battery assembly of claim 7, wherein a second battery cell of an adjacent group of battery cells connected in parallel is laser welded to a second cell tab.

9. The battery assembly of claim 8, wherein the first cell tab and the second cell tab are in electrical contact.

10. The battery assembly of claim 8, wherein the first cell tab and the second cell tab are connected using at least one formed clip.

11. The battery assembly of claim 1, wherein the extruded housing comprises:
an extruded case;
a top cover connected to the extruded case;
a first end cover, coupled to a first end of the extruded case; and
a second end cover, coupled to a second end of the extruded case.

12. The battery assembly of claim 11, wherein the extruded case, the top cover, the first end cover, and the second end cover are bonded.

13. The battery assembly of claim 11, wherein the extruded case, the top cover, the first end cover, and the second end cover are connected to form a hermetic enclosure.

14. The battery assembly of claim 11, wherein the top cover is extruded.

15. The battery assembly of claim 11, wherein the extruded case further comprises at least one of a mounting location, a detent, or a cable support system.

16. The battery assembly of claim 1, further comprising a flame-resistant material configured to isolate the plurality of battery cells from each other and from the extruded housing.

17. A method of a battery assembly, comprising:
providing an extruded housing;
providing a plurality of battery cells within the extruded housing forming a plurality of cell blocks;
providing a circuit coupled to the plurality of cell blocks; and
connecting one or more of the plurality of cell blocks selectively in parallel or series using the circuit.

18. The method of claim 17, further comprising selectively isolated a cell block within the plurality of cell blocks from each other cell block within the plurality of cell blocks using the circuit.

19. The method of claim 18, wherein the cell block within the plurality of cell blocks comprises battery cells connected in series.

20. The method of claim 18, wherein the cell block within the plurality of cell blocks comprises battery cells connected in parallel.
